(19) United States
(12) Patent Application Publication
(10) Pub. No.: US 2005/0077334 A1
(43) Pub. Date: Apr. 14, 2005

(54) Retaining arrangement for motor vehicles

(76) Inventor: Paul M. Craig JR., Silver Spring, MD (US)

Correspondence Address: Paul M. Craig, Jr., 207 Quaint Acres Drive, Silver Spring, MD, 20904, US

(21) Appl. No.: 10/848,687

(22) Filed: May 20, 2004

Related U.S. Application Data
(60) Provisional application No. 60/510,548, filed on Oct. 14, 2003.

(51) Int. Cl. B60R 7/00; B60R 21/16

(52) U.S. Cl. 224/276; 224/277

(57) ABSTRACT

A retaining arrangement for use in motor vehicles equipped with a steering wheel having a rim connected with the steering column by way of a number of spokes; a compartment for the air bag in the steering column is covered by a cover member that disintegrates in case of deployment of the air bag; the retaining arrangement, which may be detachable or non-detachable, thereby permits fastening of a piece of paper containing, for example, driving directions, to the cover of the air bag housing so as to permit consultation of the information while driving the vehicle with no loss of steering ability and with minimal inattention to the traffic.

### FIELD OF THE INVENTION

The present invention relates to a retaining arrangement for motor vehicles, and more particularly for retaining small notes containing information such as driving instructions for use by the driver.

### BACKGROUND OF THE INVENTION

Driving instructions are not infrequently supplied these days by fax or e-mail from hotels, spas, restaurants, etc. Additionally, driving directions are obtained in the course of telephone conversations, whereby these directions are frequently scribbled down by the listener on any piece of paper at hand. Up to now, the driver in possession of such information had no safe options to consult the same while driving to the destination. Holding the sheet of paper in one hand while driving is unsatisfactory from a safety point of view because it not only requires the driver to give up the use of one hand for steering purposes, but also either obstructs the driver's vision as he looks at the piece of paper held in front of his face or requires movements of the driver's head when the paper is held to the side, thereby diverting the driver's attention from the road.

Navigational systems, which are now available in cars, depend on the availability of up-to-date software. Moreover, even if such software is available, temporary street closings as a result of repairs, etc. are usually not available on the software, not to mention the fact that recent instructions obtained directly from the person or organization, which the driver intends to visit, are more likely to be more accurate. Additionally, the cost factor of navigational systems may discourage many car buyers from including at this time this optional equipment in their purchase list.

Projection systems that project instrument panel information into the windshield and that have become available recently in some cars, also entail economic cost disadvantages as well as problems of simple use and applicability to the most varied sizes of the pieces of paper containing the information.

### SUMMARY OF THE INVENTION

It is therefore a principal object of the present invention to provide a retaining arrangement in motor vehicles that will permit the driver to consult the information preserved on a piece of paper in a safe and convenient manner. This is achieved by the use of a retaining arrangement making use of the steering wheel, and especially of the cover for the inflatable air bag in the steering wheel on which the piece of paper is to be placed and retained by one or more, preferably by two simple retaining devices, each consisting in one embodiment of this invention of an elastic band provided at each of its two ends with a hook-shaped fastening member adapted to be clamped onto the steering wheel rim. This type of fastening arrangement can be used when needed only, though it can also be left installed without any inconvenience.

The cover for the inflatable air bag is an ideal place for the piece of paper containing the information because the driver is normally so positioned in his seat that he can readily view the instrument panel through the space between spokes of the steering wheel. In other words, no significant movement of the head is necessary to consult the information because the driver, by simply shifting his or her eyes to look down a bit and/or by at most minute movements of the head, is able to view the surface of the cover for the inflatable air bag and therewith the information on the piece of paper, thereby minimizing any impairment to the operation of the vehicle.

According to another feature of this invention, the retaining arrangement according to this invention may also consist of one or more retaining clips which, if directly formed in the cover by simple cuts, form a permanent, non-detachable arrangement.

According to still another embodiment of this invention, one or more separate retaining clips may be used that are attached either detachably or non-detachably in appropriate places to the air bag cover of the steering wheel.

### BRIEF DESCRIPTION OF THE DRAWINGS

These and other objects, features and advantages of the present invention will become more apparent from the following description when taken in conjunction with the accompanying drawing which shows, for purposes of illustration only, several embodiments in accordance with the present invention, and wherein:

FIG. 1 is a schematic top plan view on a steering wheel of a motor vehicle;

FIG. 2 is a partial side elevational view of a retaining device of this invention;

FIG. 3 is a partial plan view on the retaining device of FIG. 2;

FIG. 4 is a schematic top plan view on another embodiment of a steering wheel air bag cover with a modified retaining arrangement according to this invention;

FIG. 5 is a schematic partial cross-sectional view taken along line 5-5 of FIG. 4; and

FIGS. 6a and 6b are somewhat schematic elevational views, on an enlarged scale, of two modified embodiments of a clip-like member according to this invention.

### DETAILED DESCRIPTION OF THE DRAWINGS

Referring now to the drawing wherein like reference numerals are used throughout the various views to designate like parts, reference numeral 10 generally designates a steering wheel which is shown only schematically for purposes of explaining the present invention and may be of any known construction. Depending on the model and manufacturer of the car, the spokes may be of different shape and may be located and arranged differently while the cover need not be exactly circular but of a shape to allow for other features of the motor vehicle, utilizing, for example, push buttons in the spokes or transition of the spokes to actuate onboard computer features.

The steering wheel 10 of FIG. 1 includes a rim 11 which is connected by way of spokes 12, 13, 14 and 15 with a conventional steering column (not shown) while the compartment (not shown) for the inflatable air bag is covered by cover member 16. As known, the cover member 16 is intended to disintegrate when a signal is produced by an accelerometer to inflate and deploy the air bag (not shown).

According to the present invention, a piece of paper 50 containing the information, which also may be a scrap of paper of irregular shape, is removably retained on top of the cover member 16 by two retaining devices, each consisting of a thin rubber band 20 that is connected at each end to a hook-shaped fastening member generally designated by reference numeral 30. The fastening or clamping member 30 includes a more or less rectilinear part 31 (FIG. 3) adjoined by a curved part 32 extending over more than 180° to approach the rectilinear part 32 so as to provide a clamping action in the area of constriction 34. The rectilinear part 32 may terminate in an end piece 33 that may be shaped, for example, to permit resting against a respective spoke of the steering wheel. The clamping or fastening member 30 is preferably made of a conventional plastic material which offers a certain amount of elasticity to provide the desired clamping action, and its shape is preferably matched at least approximately to the dimensions of the rim 31 of the steering wheel. The elastic band 20 is fastened to the fastening or clamping member 30 in any conventional manner, for example, by being adhesively secured or fused to the fastening or clamping member utilizing conventional techniques. In the alternative, the fastening or clamping member may also be provided with an arrangement to permit fastening of the elastic band by conventional crimping action. Furthermore, the fastening or clamping member 30 may also be provided near its free end of the rectilinear member 31 with an eyelet for threading the elastic band 20 through the eyelet and then tying or fastening the same in any conventional manner. This will also permit the user of the retaining arrangement of this invention to adjust the length of the elastic band 20 to the particular dimensions of the steering wheel as diametric dimensions thereof may vary, and also permit easy replacement of the elastic band, for example, after losing its elasticity as a result of aging.

The end part 33 of the member 30 will permit the member 30 to abut against a spoke, if so desired, thereby avoiding undesired movement of the retaining device. However, this invention does not require an end part 33, especially if an adequate clamping action is assured by member 30.

Under normal driving conditions, the retaining arrangement of this invention may be stored in a small container in the glove compartment. In case of need, it will be removed from the glove compartment so that it can be used only when the driver desires to hold a piece of paper 50 onto the cover member 16 in order to be able to consult the written instructions that are then safely displayed on the cover member 16 by the retaining device 20, 30. Apart from simplicity and convenience as well as low manufacturing costs, the present invention optimizes the location of the written instructions for the convenience of the driver without the need for the driver to undertake extensive movements of the head when consulting the written instructions and without losing the use of one hand, which would be the case when manually holding the piece of paper, and thereby maintaining optimum safety conditions.

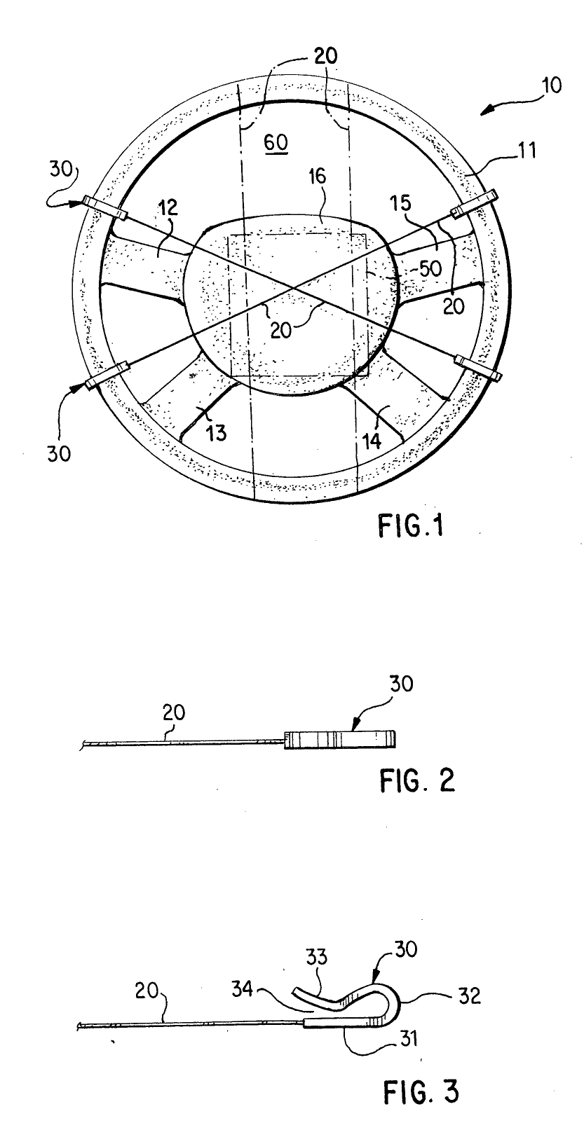

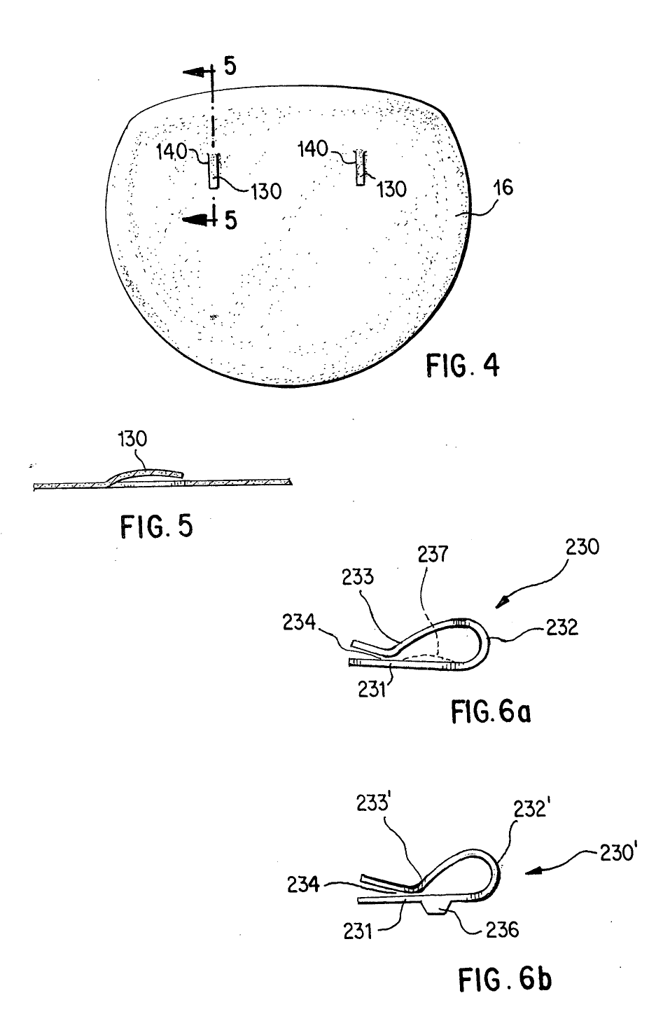

FIGS. 4 and 5 illustrate a modified embodiment of a retaining arrangement of this invention in which the retaining devices 20, 30 of FIGS. 1-3 are replaced by one or more clip-like members 130 formed, for example, by part-rectangular cuts 140 in the cover 16 itself which can then be pressed out into a clip-like shape that need not be rectilinear as schematically shown in FIG. 5, but may be deformed to receive a shape resembling the parts forming the constriction 34 of the clamping member 30. Moreover, the number and the shape of the clip-like members 130 may be different from two and may have any other known shape to achieve a holding action. Of course, the possibility of using clip-like members 130 of FIGS. 4 and 5 depends on the type and characteristics of the material used for the cover 16. The clip-like members 130 are preferably located in a substantially symmetrical manner relative to the rim of the cover 16 as shown in FIG. 4 to accommodate a large variation in the size of the paper retained thereby. However, they may also be reversed from their illustrated location by 180° and located instead substantially symmetrically with respect to the lower rim of the cover 16. Furthermore, they may also be arranged laterally, especially if only a single clip-like member is used, bearing in mind that reading the text is from left to right. In all cases the clip-like member(s) 130 should be so located as to perform their function without impairing the deployment of the air bag in cases of an emergency.

In another embodiment of this invention, the clip-like member 130 of FIGS. 4 and 5 may also be replaced by one or more clip-like members 230 and 230′ (FIGS. 6a or 6b) which are made as a separate part(s), separate from the cover 16. The clip-like members 230 and 230′ again include a more-or-less rectilinear part 231 and 231′, a re-entrant curved part 232 and 232′ that extends over more than 180° so as to form a constriction 234 and 234′. The re-entrant parts 232 and 232′ may terminate in a rectilinear end part or in a bent-up end part 233, 233′ as shown in FIG. 3. The clip-like members 230 and 230′ are preferably made from any suitable, known material with sufficient elasticity to provide the desired clamping action. It can be readily made from known plastic materials, for example, by conventional injection molding whereby it may be of uniform cross section or of different cross-sectional dimensions, for example, of larger cross section in the arcuate portion to provide a desired limited yieldingness. However, the clip-like members may also be made from any other known and suitable material, e.g., from spring steel or plastics with embedded spring steel.

The clip-like members 230 and 230′ may be non-detachably fastened to the cover 16 by any conventional means such as conventional adhesives. It may also be detachably secured to the cover 16 so as to be removable from the cover 16 when not in use, for example, by forming the rectilinear part 231 (FIG. 6a) in the shape of a small suction cup, i.e., by enlarging the part 231 into a more-or-less circular shape as viewed in plan view. The clip-like part 230′ may also be detachable or non-detachably secured in the cover 16, for example, by the use of a more-or-less conically shaped projection 236 projecting from the more-or-less rectilinear part 231′ and adapted to engage in appropriately sized openings (not shown) already provided in the cover 16. However, in lieu of a press-fit for the clip-like member 230′, a small lip or knub in the end area of the projection 236 may allow for a snap-in-like fastening of the clip-like members 230′. In that case, the thickness of the cover 16 must be taken into consideration for the length of the projection and the location of the lip or knub to assure that the lip or knub engages the underside of the cover when the part 231′ rests flush on the outside surface of the cover. The lip may also be part of a bayonet-like locking arrangement, whereby the asymmetric hole in the cover 16 for the member 230′ may be so located that the member 230′ can be inserted with its lip only in a non-final position, requiring predetermined rotation of the member 230′ into its final predetermined position once the lip has cleared the thickness of cover 16.

Depending on the nature of the material used for cover 16, it may also be desirable to treat the area of the cuts 140 (FIG. 4) or the area for the openings for projections 236 of clip-like members 230′ to impart more body, strength and/or elasticity to the cover material and/or to realize well-defined cuts if the treatment takes place prior to the cuts. This treatment may be readily realized by using an appropriate template and applying, for example, by brushing or spraying, the treating substance to well-defined and limited areas. The treating substance may be readily chosen from known available materials and/or mixtures thereof. For example, a wax-like substance with a relatively low melting point, such as paraffin, either by itself or in a mixture with other strength-imparting and/or elastic deformability-imparting characteristics, may be used depending on the nature of the cover material. Also friction-enhancing substances may be added in the embodiment of FIGS. 4 and 5. The concentration of the various substances can be readily determined empirically to optimize results which is also the case for any solvents that may be decided upon. At any rate, the available materials for such a treatment are well known in the art and their selection and use is well within the skill of a person skilled in the art and should require at most only a minimum of experimentation for a given cover material.

To minimize the danger of injury to the driver in case of deployment of the air bag, there are two precautionary measures that can be taken according to this invention. On the one hand, each clip-like member 230, 230′ is located as close as possible to the upper rim of the cover 16 so that the deploying air bag will shield the driver from injury by any loose clip-like member during the deployment of the air bag when the clip-like member may become loose and fly off into space. On the other hand, injury can be minimized by utilizing a material for the clip-like members 230, 230′ which has a low specific mass so that any loose clip-like member, even if it should hit a body part of the driver, will cause no injury. Each clip-like member 130, 230 and 230′ is preferably located close to the upper rim of the cover 16 to improve the shielding action described above. Furthermore, if the clip-like members are arranged to one side of the cover, it is preferable to arrange each clip-like member or members to the left side of the cover taking into account the convention of reading from left to right. If two clip-like members are used, they are preferably located substantially symmetrically with respect to the upper part of the cover 16. This will also accommodate pieces of paper of vastly different sizes and minimizes obstruction of the readability of the text. Of course, an analogous arrangement with respect to the lower part or side part of the rim of the cover 16 is also possible.

The constriction 134, 234, 234′ should be so chosen as to frictionally retain a single sheet of paper of standard thickness preferably without having to open the constriction at all or at least without having to open excessively the constriction when inserting the piece of paper. Dimensional standards are available for that purpose which can be taken into consideration, for example, when designing the mold for the clip-like members 230 and 230′.

While the arrangement for the clip-like members 130, 230 and 230′ and the number thereof used with the present invention as shown and described represent preferred embodiments, it is understood that the number of clip-like members, i.e., less than two or more than two and their location can be varied in accordance with the needs of a given situation, depending also on the design of the steering wheel, without departing from the spirit of the present invention. The same is true for the location of the elastic bands 20 of the fastening arrangement 10 which may run in a more-or-less vertical direction as shown in dash lines in FIG. 1 or in a more-or-less horizontal direction (not shown).

The present invention also distinguishes itself by the fact that it does not impair the proper functioning of the inflatable air bag should an accident occur even while the retaining arrangement is in use. Moreover, to further enhance the safety, the elastic bands 20 may be provided with a slight cross-sectional reduction, for example, by a partial pre-cut in the area intermediate the two clamping members 30 to assure breakage of the elastic band in that area should the air bag inflate that causes the cover to disintegrate. Additionally, one or more members 130, 230, 230′ may also be used in conjunction with one of the retaining arrangements of FIGS. 1-3, for example, by retaining a piece of paper retained by members 130 of FIG. 4 with an arrangement of FIGS. 1-3 involving a substantially horizontally extending elastic member holding down the lower end of the piece of paper.

It may also be desirable to provide an overhead light in the car producing a directional beam of light to illuminate the cover of the airbag to enable reading of the information arranged on the airbag cover at low lighting or at night. To minimize interference with night driving the directional beam should be so limited by conventional means that substantially only the area of the airbag cover is illuminated. For example, a more or less conical beam of light that can be readily realized, may be useful for that purpose.

While I have shown and described several embodiments in accordance with the present invention, it is understood that the same is not limited thereto, but is susceptible of numerous changes and modifications as known to those skilled in the art. I therefore do not wish to be limited to the details shown and described herein but intend to cover all such changes and modifications as are encompassed by the scope of the appended claims.

1. A retaining arrangement for a motor vehicle equipped with a steering wheel having an external rim, an air bag housing connected with the rim by way of spokes, and a disintegrating cover for the air bag housing, comprising means for retaining a piece of paper on the cover in such a manner as not to impair proper functioning of the inflatable air bag.

2. A retaining arrangement according to claim 1, wherein said means includes at least one retaining device consisting of a thin elastic band provided at each end with a clamping member for clamping the same onto the steering wheel rim.

3. A retaining arrangement according to claim 1, wherein said further means includes at least one clip-like member.

4. A retaining arrangement according to claim 3, wherein said clip-like member is formed in the cover itself.

5. A retaining arrangement according to claim 3, wherein said clip-like member is separate from said cover and is fastened thereto.

6. A retaining arrangement according to claim 5, wherein said clip-like member is fixedly arranged on said cover.

7. A retaining arrangement according to claim 5, wherein said clip-like member is detachable secured to said cover.

8. A retaining arrangement according to claim 3, wherein two clip-like members are arranged substantially symmetrically with respect to the rim of said cover.

9. A retaining arrangement according to claim 8, wherein the two clip-like members are arranged substantially symmetrically with respect to one of the upper and of the lower parts of the rim of said cover.

10. A retaining arrangement according to claim 5, wherein each clip-like member is arranged on said cover in such a manner that the air bag, during deployment thereof, shields the driver from injury by the clip-like member.

11. A retaining arrangement according to claim 5, wherein each clip-like member is made from a plastic material with a low specific mass.

12. A retaining arrangement according to claim 5, wherein two clip-like members are arranged substantially symmetrically with respect to the rim of said cover.

13. A retaining arrangement according to claim 12, wherein the two clip-like members are arranged substantially symmetrically with respect to one of the upper and of the lower parts of the rim of said cover.

14. A retaining arrangement according to claim 3, wherein each clip-like member is arranged on said cover in such a manner that the air bag, during deployment thereof, shields the driver from injury by the clip-like member.

15. A retaining arrangement according to claim 3, wherein the area of the cover, limited substantially to where each clip-like member is located, is treated to enhance the characteristics of the cover material.
